(19) United States
(12) Patent Application Publication
(10) Pub. No.: US 2025/0052929 A1
(43) Pub. Date: Feb. 13, 2025

(54) COMPOSITE FILM STRUCTURE AND DISPLAY MODULE

(71) Applicant: Yungu (Gu’an) Technology Co., Ltd., Langfang (CN)

(72) Inventors: Qingxu ZHOU, Langfang (CN); Yuchen TIAN, Langfang (CN); Shuhuan ZHANG, Langfang (CN)

(73) Assignee: Yungu (Gu’an) Technology Co., Ltd., Langfang (CN)

(21) Appl. No.: 18/933,272

(22) Filed: Oct. 31, 2024

(30) Foreign Application Priority Data
Nov. 28, 2023 (CN) 202311604825.X

(51) Int. Cl. G02B 1/14; G06F 1/16

(52) U.S. Cl. CPC G02B 1/14; G06F 1/1656

(57) ABSTRACT

A composite film structure and a display module. The composite film structure includes a first protective layer comprising a first protective portion and at least one second protective portion disposed on an outer periphery side of the first protective portion, and the first protective portion and the second protective portion being at least partially spaced apart from each other, a composite film body disposed on a side of the first protective layer in a thickness direction, and including a first sub-portion and a second sub-portion surrounding a periphery of the first sub-portion, an orthographic projection of the first sub-portion on the first protective layer being at least partially located within the first protective portion, and an orthographic projection of the second sub-portion on the first protective layer being located outside the first protective portion and overlapping with the second protective portion.

### CROSS REFERENCE

The present disclosure claims priority to Chinese Patent Application No. 202311604825.X titled “COMPOSITE FILM STRUCTURE, DISPLAY MODULE, PREPARATION METHOD THEREOF AND DISPLAY DEVICE” filed on Nov. 28, 2023, which is incorporated herein by reference in its entirety.

### TECHNICAL FIELD

The present disclosure relates to the technical field of display apparatus, in particular to a composite film structure, a display module, a preparation method thereof and a display device.

### BACKGROUND

With a development of science and technology, a display device has continuously advanced, and users' requirements for the display device have gradually increased. However, during a preparation process of a display module in the display device, a local deformation usually occurs at an edge of the display module, affecting a structural reliability of the display module.

### SUMMARY

Embodiments of the present disclosure provide a composite film structure, a display module, a preparation method thereof and a display device capable of improving a reliability during preparation.

In a first aspect, an embodiment of the present disclosure provides a composite film structure for a display module. The composite film structure includes a first protective layer, comprising a first protective portion and a second protective portion disposed on an outer periphery side of the first protective portion, and the first protective portion and the second protective portion being at least partially spaced apart from each other; and a composite film body, disposed on a side of the first protective layer in a thickness direction, and comprising a first sub-portion and a second sub-portion surrounding an periphery of the first sub-portion, an orthographic projection of the first sub-portion on the first protective layer being at least partially located within the first protective portion, and an orthographic projection of the second sub-portion on the first protective layer being located outside the first protective portion and overlapping with the second protective portion.

In some embodiments, the composite film structure further includes a second protective layer disposed on a side of the composite film body away from the first protective layer, wherein an orthographic projection of the second protective layer on the first protective layer overlaps with the orthographic projection of the second sub-portion on the first protective layer.

In some embodiments, the second protective layer is configured to be separable from the composite film body along a first direction, and the second protective portion is located at least on one side of the first protective portion in the first direction.

In some embodiments, a dimension of the composite film body in the first direction is smaller than a dimension of the composite film body in a second direction, with both the first direction and the second direction being parallel to a plane where the first protective layer is located and intersecting each other. The second protective portion extends in the second direction.

In some embodiments, in the first direction, the second protective portion extends beyond the composite film body.

In some embodiments, in the first direction, the second protective portion extends beyond the composite film body by L1, wherein 0.4 mm≤L1≤0.6 mm.

In some embodiments, a dimension of a part of the second sub-portion that abuts the second protective portion in the first direction is L2, wherein 0.9 mm≤L2≤1.1 mm is satisfied.

In some embodiments, the second protective portion is connected to the first protective portion.

In some embodiments, the first protective portion and the second protective portion form an integral structure.

In some embodiments, the second protective portion includes a first division that is spaced apart from the first protective portion, and a second division that connects the first division to the first protective portion.

In some embodiments, a plurality of second divisions are provided and spaced apart from each other around an outer peripheral edge of the first protective portion.

In some embodiments, the composite film body further includes a cushion layer and a support layer stacked sequentially in a direction towards the first protective layer. An orthographic projection of at least one of the support layer and the cushion layer on the first protective layer overlaps with the second protective portion;

In some embodiments, an orthographic projection of each of the support layer and the cushion layer on the first protective layer overlaps with the second protective portion.

In some embodiments, the composite film body further includes an insulating layer disposed between the support layer and the cushion layer.

In some embodiments, an orthographic projection of the insulating layer on the first protective layer overlaps with the second protective portion.

In some embodiments, the composite film body further includes a reinforcing member at least partially located within the second sub-portion, with a structural strength of the reinforcing member being greater than that of each of the support layer and the cushion layer. In some embodiments, a material of the reinforcing member includes alloy.

In some embodiments, an orthographic projection of the reinforcing member on the first protective layer overlaps with the second protective portion.

In some embodiments, the reinforcing member is connected to at least one of the support layer or the cushion layer.

In some embodiments, the reinforcing member includes a first reinforcing portion disposed around a periphery of at least one of the support layer or the cushion layer. And/or, the reinforcing member includes a second reinforcing portion, and an orthographic projection of the second reinforcing portion on the first protective layer overlaps with an orthographic projection of at least one of the support layer or the cushion layer on the first protective layer.

In some embodiments, at least one of the support layer or the cushion layer is provided with a hollow accommodating space, within which the second reinforcing portion is disposed.

In some embodiments, the second reinforcing portion is embedded between the support layer and the cushion layer.

In some embodiments, an outer peripheral surface of the second reinforcing portion is flush with an outer peripheral surface of at least one of the support layer or the cushion layer;

In some embodiments, the reinforcing member includes both the first reinforcing portion and the second reinforcing portion, with the first reinforcing portion connected to the second reinforcing portion.

In some embodiments, a material of the first reinforcing portion includes epoxy resin.

In a second aspect, embodiments of the present disclosure provide a composite film structure for a display module. The composite film structure includes a first protective layer and a composite film body, the first protective layer includes a first protective portion and a second protective portion disposed on an outer periphery side of the first protective portion, and the first protective portion and the second protective portion are separate and interconnected. The composite film body is disposed on a side of the first protective layer in a thickness direction, with both the first protective portion and the second protective portion abutting the composite film body.

In some embodiments, the second protective portion is located on at least one side of the first protective portion in the first direction, and the second protective portion extends beyond the composite film body in the first direction.

In some embodiments, the composite film structure further includes a second protective layer disposed on a side of the composite film body away from the first protective layer, with an orthographic projection of the second protective layer on the first protective layer overlaps with an orthographic projection of the second sub-portion on the first protective layer.

In some embodiments, the second protective layer is configured to be separable from the composite film body in the first direction.

In some embodiments, the composite film body further includes a first sub-portion and a second sub-portion surrounding a periphery of the first sub-portion.

The composite film body further includes a reinforcing member, and at least part of the reinforcing member is located within the second sub-portion.

In some embodiments, a material of the reinforcing member includes alloy.

In some embodiments, an orthographic projection of the reinforcing member on the first protective layer overlaps with the second protective portion.

In a third aspect, embodiments of the present disclosure provide a display module. The display module includes a display screen, a composite film body and a first protective layer. The display screen is provided with a light-emitting surface and a backlight surface opposite to each other. The first protective layer is disposed on a side of the composite film body away from the display screen, and includes a first protective portion and a second protective portion disposed on an outer periphery side of the first protective portion, an orthographic projection of the first protective portion on the first protective layer is located within the first protective portion, and an orthographic projection of the second protection portion on the first protective layer is located outside the first protective portion and overlaps with the second protective portion.

In a fourth aspect, embodiments of the present disclosure provide a display device. The display device includes a display screen with a light-emitting surface and a backlight surface, the composite film body as described in the afore-mentioned display module and a middle frame structure. The composite film body is disposed on a side of the display screen where the backlight surface is provided. The middle frame structure is at least partially disposed on a side of the composite film body away from the display screen, and abuts the composite film body.

In some embodiments, a structural strength of the first sub-portion is smaller than that of the second sub-portion.

In some embodiments, the composite film body includes a reinforcing member, and at least part of the reinforcing member is located within the second sub-portion.

In a fifth aspect, embodiments of the present disclosure provide a preparation method for a display module, including steps of:
providing the composite film structure of any one of the above embodiments;
separating the second protective layer from the composite film body;
abutting a side of the composite film body away from the first protective layer to the display screen.

In some embodiments, the preparation method further includes a step of separating the second protective portion from the first protective portion, so as to separate the second protective portion from the composite film body.

Embodiments of the present disclosure provide the composite film structure, the display module, the preparation method thereof, and the display device. In addition to the first protective portion, the first protective layer further includes the second protective portion. The first protective portion is provided corresponding to the first sub-portion of the composite film body, and the second protective portion is provided corresponding to the second sub-portion of the composite film body. In this way, during a separation process of other film layers from a side of the composite film body away from the first protective layer, a tensile deformation of the first sub-portion can be reduced via the first protective portion during the separation process, and a tensile deformation of the second sub-portion can be reduced via the second protective portion during the separation process, thereby reducing a corresponding deformation degree of the first sub-portion and the second sub-portion, lowering a risk of wave-like patterns occurring at the second sub-portion, and improving a structural reliability of the composite film body in the display module, which contributes to enhancing the structural reliability of the ultimately formed display device.

### BRIEF DESCRIPTION OF THE DRAWINGS

To more clearly illustrate technical solutions of embodiments of the present disclosure, a brief introduction of drawings required in the embodiments of the present disclosure will be provided below. For those skilled in the art, other drawings can also be obtained based on these figures without creative labor.

FIG. 1 is a schematic structural diagram of a composite film structure provided in an embodiment of the present disclosure;

FIG. 2 is a cross-sectional structural schematic diagram taken along line A-A in FIG. 1;

FIG. 3 is a cross-sectional structural schematic diagram of another composite film structure provided in an embodiment of the present disclosure;

FIG. 4 is a structural schematic diagram of a first protective layer in another composite film structure provided in an embodiment of the present disclosure;

FIG. 5 is a cross-sectional structural schematic diagram of another composite film structure provided in an embodiment of the present disclosure;

FIG. 6 is a cross-sectional structural schematic diagram of another composite film structure provided in an embodiment of the present disclosure;

FIG. 7 is a cross-sectional structural schematic diagram of another composite film structure provided in an embodiment of the present disclosure;

FIG. 8 is a cross-sectional structural schematic diagram of another composite film structure provided in an embodiment of the present disclosure;

FIG. 9 is a cross-sectional structural schematic diagram of another composite film structure provided in an embodiment of the present disclosure;

FIG. 10 is a cross-sectional structural schematic diagram of another composite film structure provided in an embodiment of the present disclosure;

FIG. 11 is a cross-sectional structural schematic diagram of a display module provided by an embodiment of the present disclosure;

FIG. 12 is a cross-sectional structural schematic diagram of a display device provided in an embodiment of the present disclosure;

FIG. 13 is a cross-sectional structural schematic diagram of another display device provided in an embodiment of the present disclosure;

FIG. 14 is a flow chart of a preparation method for a display module provided in an embodiment of the present disclosure;

FIGS. 15A to 15C are process structure schematic diagrams of a preparation method for a display module provided in an embodiment of the present disclosure;

FIG. 16 is a flow chart of a preparation method for a display module provided in an embodiment of the present disclosure;

FIG. 17 is a process structure schematic diagram of a preparation method for a display module provided by an embodiment of the present application.

### DESCRIPTION OF REFERENCE SIGNS

10, first protective layer; 11, first protective portion; 12, second protective portion; 121, first division; 122, second division;
20, composite film body; 21, first sub-portion; 22, second sub-portion; 23, cushion layer; 24, support layer; 25, insulating layer; 26, reinforcing member; 261, first reinforcing portion; 262, second reinforcing portion;
30, second protective layer;
40, display screen;
50, middle frame structure;
X, first direction; Y, second direction; Z, thickness direction.

### DETAILED DESCRIPTION

Features and exemplary embodiments of aspects of the present disclosure will be described in detail below. In order to make objectives, technical solutions, and advantages of the present disclosure clearer, a further detailed description of the present disclosure will be provided below in conjunction with the drawings and specific embodiments. It should be understood that the specific embodiments described herein are intended to explain, rather than limit the present disclosure. For those skilled in the art, the present disclosure can be implemented without some of the specific details. The description of the embodiments is merely to provide a better understanding of the present disclosure by examples of the present disclosure.

It should be noted that in the text, relational terms such as first and second are used solely to distinguish one entity or operation from another and do not necessarily require or imply any such actual relationship or sequence between the entities or operations. Moreover, the terms “including”, “comprising” or any other variations thereof are intended to encompass non-exclusive inclusion, thereby indicating that a process, method, article, or device including a list of elements not only includes those elements but also includes other elements that are not expressly listed, or inherently includes elements that are inherent to such a process, method, article, or device. Without further limitation, an element defined by the phrase “including . . . ” does not exclude an existence of additional identical elements in the process, method, article, or device that includes the element.

In related art, a display module is typically an intermediate product to form a display device. A backlit side of a display screen in the display module is usually provided with a composite film body, which includes a plurality of stacked film layers for buffering, shielding, heat dissipation, support, etc. The composite film body is usually prepared separately from the display screen in different process steps, and two protective films are typically provided on both sides of the composite film body.

During the preparation of the display module, one of the protective films is usually removed from the composite film body so that the composite film body can be adhered and fixed to the display screen. However, due to the influence of processes and other factors, the other protective film typically cannot completely cover the composite film body. As a result, during the above-mentioned film removal process, the other protective film cannot provide support at all positions of the composite film body, leading to the composite film body being pulled and deformed at edge positions, which results in an abnormal phenomenon of edge wave patterns, affecting the structural reliability of the display module and the subsequent display device formed therefrom.

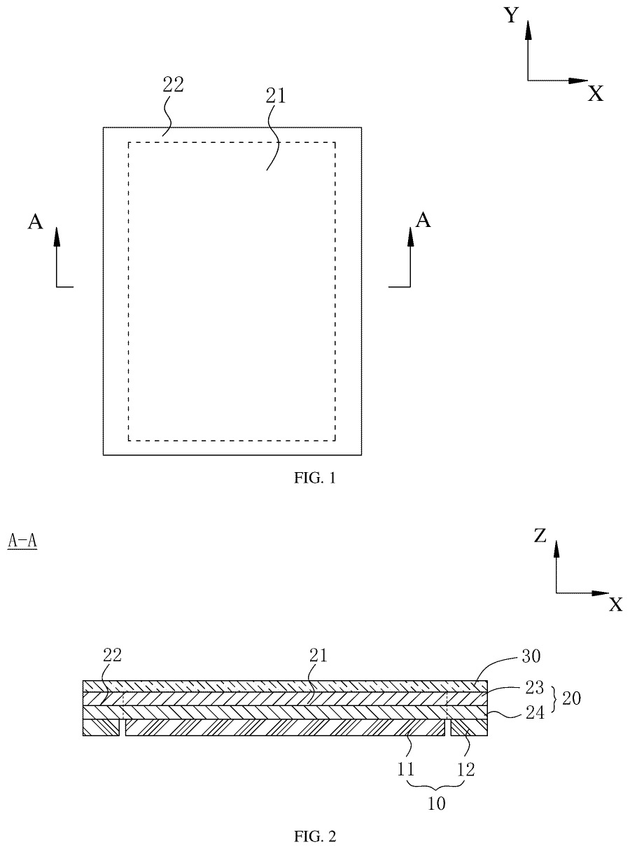

In view of this, in a first aspect, please refer to FIG. 1 and FIG. 2, embodiments of the present disclosure provide a composite film structure for a display module. The composite film structure includes a first protective layer 10 and a composite film body 20. The first protective layer 10 includes a first protective portion 11 and a second protective portion 12 disposed on an outer periphery side of the first protective portion 11. The first protective portion 11 and the second protective portion 12 are at least partially spaced apart from each other. The composite film body 20 is disposed on a side of the first protective layer 10 in a thickness direction Z and includes a first sub-portion 21 and a second sub-portion 22 surrounding a periphery of the first sub-unit 21. An orthographic projection of the first sub-portion 21 on the first protective layer 10 is at least partially located within the first protective portion 11, and an orthographic projection of the second sub-portion 22 on the first protective layer 10 is located outside the first protective portion 11 and overlaps with the second protective portion 12. In FIG. 1, the first sub-portion 21 is indicated by a dashed line box.

The composite film structure is configured to form a display module. Specifically, a protective film or other structures may be provided on a side of the composite film body 20 away from the first protective layer 10. During an installation process of the composite film body 20 with the display screen 40, the protective film or other structures can be separated and removed from the composite film body 20, so that the side of the composite film body 20 away from the first protective layer 10 can be exposed, and thereby the side of the composite film body 20 away from the first protective layer 10 can be adhered and fixed to the display screen 40, thus forming the display module.

The first protective layer 10 is provided on both sides of the composite film body 20 in the thickness direction Z and serves to support and protect the composite film body 20. The thickness directions Z of the first protective layer 10 and the composite film body 20 are the same. Furthermore, the thickness direction Z of film layers within the display module and the display device the film layer formed by the composite film body 20 provided in the embodiments of the present disclosure typically aligns with the aforementioned thickness direction Z. For ease of description, the thickness of the first protective layer 10, the composite film body 20, an inner film layer structure of the display module, and an inner film layer structure of the display device will be indicated with the same arrow direction in the subsequent description of the embodiments of the present disclosure.

The composite film body 20 is a main part of the composite film structure and can include a plurality of film layer stacked in the thickness direction Z. The composite film body 20 will be located inside the ultimately formed display device, and the plurality of stacked film layers within the composite film body 20 can serve roles such as buffering, shielding, heat dissipation, support, etc. to meet the usage needs of the display device. The specific composition of the film layers within the composite film body 20 is not limited in the embodiments of the present disclosure.

The composite film body 20 includes the first sub-portion 21 and the second sub-portion 22 surrounding a periphery of the first sub-portion 21. The first sub-portion 21 is located at a central position of the composite film body 20, while the second sub-portion 22 is located at an edge position of the composite film body 20. The specific shape and size of the first sub-portion 21 and the second sub-portion 22 need to be determined based on the display module and display device that are subsequent formed, which is not limited in the embodiments of the present disclosure. For example, the orthographic projection of the first sub-portion 21 on the first protective layer 10 can be square, while the orthographic projection of second sub-portion 22 on the first protective layer 10 can be a ring with a square edge; or the orthographic projection of the first sub-portion 21 on the first protective layer 10 can be circular structure, while the orthographic projection of the second sub-unit 22 on the first protective layer 10 can be circular.

For the first protective layer 10, in the related art, due to the influence of process factors, a contour of the first protective layer 10 is typically internally shrank relative to the composite film body 20, such that it only includes the first protective portion 11. The first protective portion 11 covers and supports at least a part of the first sub-portion 21 of the composite film body 20 but cannot cover and support the second sub-portion 22.

The above design can lead to a situation where, during the separation process of other film layers on the side of the composite film body 20 away from the first protective layer 10, the first protective portion 11 can only help reduce deformation of the first sub-portion 21 due to a pulling force by the other film layers, but cannot prevent a deformation of the second sub-portion 22 due to a pulling force by the other film layers, thus causing the second sub-portion 22 to easily deform and exhibit a wavy shape.

In the embodiments of the present disclosure, in addition to the first protection portion 11, the first protection layer 10 may also include a second protection portion 12 arranged on a periphery side of the first protection portion 11. The specific positional relationship between the first protection portion 11 and the second protection portion 12 is not limited in the embodiments of the present disclosure. Optionally, the second protection portion 12 may be in a ring structure and surrounds an outer periphery of the first protection portion 11. Alternatively, the second protection portion 12 may be located only on one or both sides of the first protection section 11 in a single direction. Further, the first protection portion 11 and the second protection portion 12 may be connected to each other and arranged, or may also be separated from each other and arranged to be spaced apart from each other.

The first protection portion 11 is correspondingly arranged with the first sub-portion 21 in the composite film body 20, and the orthographic projection of the first sub-portion 21 on the first protection layer 10 is located in the first protection portion 11. The second protection portion 12 is correspondingly arranged with the second sub-portion 22, and the orthographic projection of the second sub-portion 22 on the first protection layer 10 is positioned outside the first protection portion 11, and overlaps with the second protection portion 12.

The specific positional relationship between the second protection portion 12 and the second sub-portion 22 is not limited in the embodiments of the present disclosure. Optionally, the second protection portion 12 may cover only part of the second sub-portion 22, that is, the orthographic projection of part of the second sub-portion 22 on the first protection layer 10 is located outside the second protection portion 12. Or, the second protection portion 12 can completely cover the second sub-portion 22, that is, the orthographic projection of the second sub-portion 22 on the first protection layer 10 is completely located in the second protection portion 12.

Further, the outer contour of the second protection portion 12 may completely or partially exceed the second sub-portion 22, or the outer contour of the second protection portion 12 may also be flush with the outer contour of the second sub-portion 22, or the outer contour of the second protection portion 12 may also be internally shrank relative to the outer contour of the second sub-portion 22, which is not limited in the embodiments of the present disclosure.

In the embodiments of the present disclosure, in addition to the first protection portion 11, the first protection layer 10 includes the second protection portion 12. The first protection portion 11 corresponds to the first sub-portion 21 of the composite film body 20, and the second protection portion 12 corresponds to the second sub-portion 22 of the composite film body 20. In this way, in the process of separating the other film layers on a side of the composite film body 20 away from the first protective layer 10 and the composite film body 20, the first protective portion 11 can reduce a pulling deformation of the first subpart 21 in the separation process, and the second protective portion 12 can reduce a pulling deformation of the second sub-portion 22 in the separation process, so as to reduce the deformation degree of the first sub-portion 21 and the second sub-portion 22, reduce the risk of wavy shape appearing at the second sub-portion 22, and improve the structural reliability of the composite film body 20 in the display module, which in turn helps to improve the structural reliability of the display device that is finally formed.

Further, in the embodiments of the present disclosure, the first protection portion 11 and the second protection portion 12 can be arranged at least partially to be spaced apart from each other, and compared with the scheme that the first protection portion 11 and the second protection portion 12 are completely connected and integrated, the above scheme can reduce the risk of deformation of the composite film body 20 and facilitate the separation of the second protection portion 12 and the first protection portion 11 in a later stage, so as to realize the separation between the second protection portion 12 and the composite film body 20, thereby facilitating a subsequent edge reinforcement coating process of the composite film body 20 to meet actual production needs.

It should be noted that, although the first protection portion 11 and the second protection portion 12 are at least partially spaced from each other, the first protection portion 11 and the second protection portion 12 can be selectively connected at some positions according to actual needs, or may be completely spaced from each other, which is not limited in the embodiments of the present disclosure.

In some embodiments, the composite film structure further includes a second protective layer 30 located on a side of the composite film body 20 away from the first protective layer 10, and the orthographic projection of the second protective layer 30 on the first protective layer 10 overlaps with the orthographic projection of the second sub-portion 22 on the first protective layer 10.

The second protective layer 30 can be in a planar structure and completely cover the composite film body 20, that is, the orthographic projection of the second protective layer 30 on the first protective layer 10 can simultaneously cover the orthographic projection of each of the first sub-portion 21 and the second sub-portion 22 on the first protective layer 10. The contour shape of the second protective layer 30 can be completely arranged corresponding to the contour shape of the composite film body 20, or the second protective layer 30 may also partially exceed the outer contour of the composite film body 20.

In the embodiments of the present disclosure, in the process of separating the second protective layer 30 from the composite film body 20, the first protective portion 11 can reduce the pulling deformation of the first sub-portion 21 caused by the second protective layer 30, and the second protective portion 12 can reduce the pulling deformation of the second sub-portion 22 caused by the second protective layer 30, thereby reducing the deformation degree of the first sub-portion 21 and the second sub-portion 22, reducing the risk of wavy shape appearing at the second sub-portion 22, and improving the structural reliability of the composite film body 20 in the display module, which in turn helps to improve the structural reliability of the display device that is finally formed.

In some embodiments, as shown in FIG. 1 and FIG. 2, the second protective layer 30 is configured to be separable relative to the composite film body 20 in the first direction X, and the second protective portion 12 is located on at least a side of the first protective portion 11 in the first direction X.

The first direction X is a tearing film direction for the second protective layer 30 relative to the composite film body 20. Specifically, in the process of separating the composite film body 20 and the second protective layer 30, a bonding size of the composite film body 20 and the second protective layer 30 in the first direction X is gradually decreasing. Further, part of the second sub-portion 22 located on both sides of the first sub-portion 21 in the first direction X are more easily to be pulled by the second protective layer 30 and therefore more prone to deformation.

In view of this, in the embodiments of the present disclosure, the second protection portion 12 is not arranged around the first protection portion 11, but is located at least one side of the first protection portion 11 along a single direction, that is, the first direction X, so that the second protection portion 12 can be correspondingly arranged with the part of the second sub-portion 22 located on both sides of the first sub-portion 21 in the first direction X, thereby reducing the degree of the puling deformation of the part of the second sub-portion 22 located on both sides of the first sub-portion 21 in the first direction X, to improve the structural reliability of the composite film body 20 in the prepared display module.

It should be noted that in the embodiments of the present disclosure, one second protection portion 12 may be provided, and located on a side of the first protection portion 11 in the first direction X. Alternatively, two or even more second protection portions 12 may be provided, and are arranged on both sides of the first protection portion 11 in the first direction X

In some embodiments, as shown in FIG. 1 and FIG. 2, a dimension of the composite film body 20 in the first direction X is smaller than a dimension of the composite film body 20 in the second direction Y, and both the first direction X and the second direction Y are parallel to a plane where the first protective layer 10 is located and intersect each other. The second protection portion 12 extends in the second direction Y.

The composite film body 20 has different dimensions respectively in the first direction X and the second direction Y. Optionally, the first direction X is perpendicular to the second direction Y. The orthographic projection of the composite film body 20 on the first protective layer 10 can be square, the first direction X can correspond to an extension direction of a short side of the composite film body 20, and the second direction Y can correspond to an extension direction of a long side on the composite film body 20.

In the related art, the second protective layer 30 is usually separated from the composite film body 20 in the short side of the composite film body 20, i.e., the first direction X. Therefore, an edge of the long side of the composite film body 20 in the first direction X is more likely to be pulled by the second protective layer 30, thereby causing deformation.

In view of this, in the embodiments of the present disclosure, the second protection portion 12 is arranged on at least one side of the first protection portion 11 in the first direction X, and extends in the second direction Y. That is, the second protection portion 12 can extend in the long side of the composite film body 20, to better cover the edge of the long side of the composite film body 20, and further reduce the risk that the edge of the long side of the composite film body 20 is separated from the second protective layer 30 which causes excessive deformation.

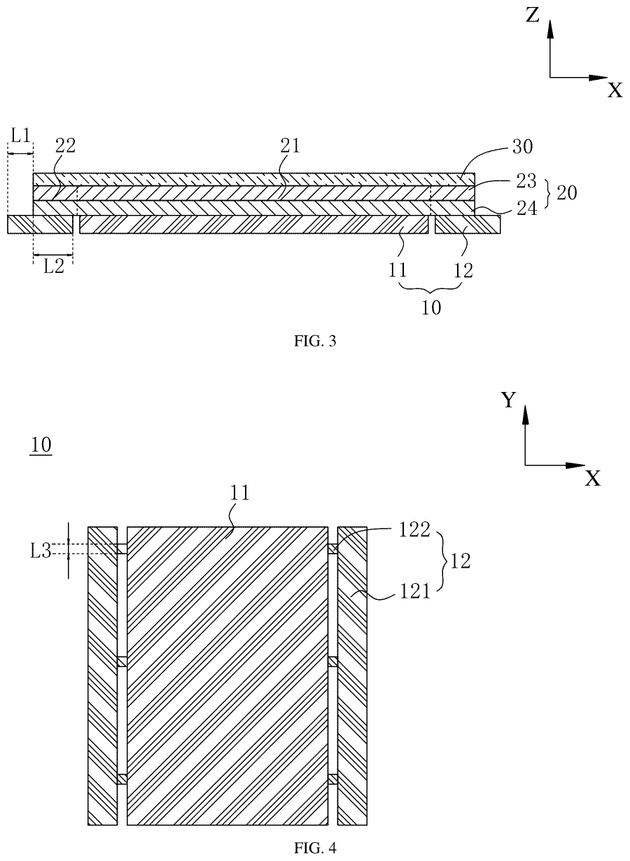

In some embodiments, see FIG. 3, in the first direction X, the second protection portion 12 extends beyond the composite film body 20.

In the embodiments of the present disclosure, the second protective portion 12 is arranged beyond the composite film body 20 in the first direction X, so that the second protective portion 12 can cover the edge of a side of the second sub-portion 22 away from the first sub-portion 21, and thus the composite film body 20 is supported by the second protective portion 12 at its edge position, thereby further reducing the risk that the edge of the composite film body 20 is deformed and produces a wavy shape during the separation process from the second protective layer 30.

In some embodiments, as shown in FIG. 3, in the first direction X, a dimension of the second protection portion 12 extends beyond the composite film body 20 by L1, and 0.4 mm≤L1≤0.6 mm is satisfied. Optionally, L1 is 0.4 mm, 0.45 mm, 0.5 mm, 0.55 mm, or 0.6 mm.

If the size of the second protection portion 12 beyond the composite film body 20 in the first direction X is too large, the material for the second protective portion 12 will be wasted, and a bonding strength between the second protective portion 12 and the composite film body 20 will be affected, causing the risk of the second protective portion 12 falling from the composite film body 20. Therefore, in the embodiments of the present disclosure, L1 is set to be not more than 0.6 mm, so that the bonding reliability between the second protection portion 12 and the composite film body 20 can be improved, and the material waste is reduced simultaneously.

In addition, if the size of the second protective portion 12 beyond the composite film body 20 in the first direction X is too small, the second protective portion 12 may not be able to completely cover the edge of the composite film body 20 due to the influence of factors such as the bonding accuracy between the second protective portion 12 and the composite film body 20, and the edge of the composite film body 20 still may be deformed excessively. Therefore, in the embodiments of the present disclosure, L1 is set to be not less than 0.4 mm, so that the second protection portion 12 reliably covers the edge of the composite film body 20, and the risk of wavy shape at the edge of the composite film body 20 is further reduced.

In some embodiments, a dimension of the part of the second sub-portion 22 abutting the second protection portion 12 in the first direction X are L2, and 0.9 mm≤L2≤1.1 mm L2 is satisfied. Optionally, L2 is 0.9 mm, 0.95 mm, 1 mm, 1.05 mm, and 1.1 mm.

According to the actual situation, the entire second sub-portion 22 can abut the second protection portion 12, or only part of the second sub-portion 22 can abut the second protection portion 12. Further, if L2 of the part of the second sub-portion 22 abutting the second protection portion 12 in the first direction X is too large, it is not conducive for the second protection portion 12 to be separated from the composite film body 20 later. Therefore, in the embodiments of the present disclosure, L2 is set to be no more than 1.1 mm, so that after the display module is prepared, the second protection portion 12 can be separated from the composite film body 20.

In addition, if L2 of the part of the second sub-portion 22 abutting the second protective portion 12 in the first direction X is too small, the bonding strength between the second protective portion 12 and the composite film body 20 will be affected, causing the risk of the second protective portion 12 falling from the composite film body 20, and an insufficient support on the second sub-portion 22 by the second protective portion 12. Therefore, in the embodiments of the present disclosure, L2 is set to be not less than 0.9 mm, so that the bonding reliability between the second protection portion 12 and the composite film body 20 can be improved, and the support reliability of the second protection portion 12 for the second sub-portion 22 can also be improved.

In some embodiments, see FIG. 3 and FIG. 4, and the second protection portion 12 is connected to the first protection portion 11.

In the embodiments of the present disclosure, the first protection portion 11 is connected with the second protection portion 12, to improve the reliability of the relative position between the first protection portion 11 and the second protection portion 12, and reducing the risk of the second protection portion 12 sliding relative to the first protection portion 11 under the influence of external forces and other factors, so as to indirectly improve the reliability of the relative position between the second protection portion 12 and the second subsection 22.

It should be noted that the first protection portion 11 and the second protection portion 12 may be prepared and molded together with the same material, or may also be prepared separately with different materials, and then connected and fixed by bonding or other means. Optionally, the first protection portion 11 and the second protection portion 12 are in an integrated structure, so that the first protection portion 11 and the second protection portion 12 can be formed simultaneously in the same preparation process, and the preparation efficiency of the first protection layer 10 is improved.

In some embodiments, as shown in FIG. 4, the second protection portion 12 includes a first division 121 arranged to be spaced apart from the first protection portion 11 and a second division 122 connecting the first division 121 to the first protection portion 11.

The first division 121 is a main part of the second protection portion 12, the first division 121 and the first protection portion 11 are arranged to be spaced apart from each other, and the specific shape and size of the first division 121 is not limited in the embodiments of the present disclosure. For example, the first division 121 may be in a ring structure and arranged around an outer periphery of the first protection portion 11, or the first division 121 may be in a strip structure extending in the second direction Y.

The second division 122 is located between the first division 121 and the first protection portion 11 and is configured for connecting and fixing the first protection portion 11 with the first division 121. The specific shape and size of the second division 122 is not limited in the embodiments of the present disclosure. For example, the second division 122 may be in the form of a ring, strip, block, etc. Further, depending on the actual situation, the number of the second division 122 can be one, or multiple.

In addition, the first division 121 and the second division 122 may be made of the same material, or different materials, and optionally, the first division 121 and the second division 122 may be made of the same material to be prepared and molded together in the same process. Optionally, the dimensions of the first division 121 and the second division 122 in the thickness direction Z are the same, which helps to reduce the difficulty of preparation of the first division 121 and the second division 122.

In the embodiments of the present disclosure, the second protection portion 12 includes the first division 121 and the second division 122. The first division 121 is a main structure in the second protection portion 12 to support the second sub-portion 22. The second division 122 is configured for connecting and fixing the first protection portion 11 and the first division 121, thereby improving the position stability of the first division 121 and the first protection portion 11 relative to the composite film body 20, then improving the support effect of the second division 122 at the edge of the composite film body 20 in the process of separating the second protective layer 30 from the composite film body 20, to reduce the risk of wavy shape, and improving a yield rate of display module prepared.

In some embodiments, a plurality of second divisions 122 are provided and arranged to be spaced apart from each other at an outer peripheral edge of the first protection portion 11.

The plurality of second divisions 122 are configured for connecting the first protection portion 11 and the first division 121, and arranged at different positions at the peripheral edge of the first protection portion 11 to improve the connection reliability of the first protection portion 11 and the first division 121 at different positions, so as to further improve the stability of the relative position between the first protection portion 11 and the first division 121. At the same time, the plurality of second divisions 122 are arranged to help to reduce the size of a single second division 122, so that when the display module is formed, the second division 122 can be separated from the first protection section 11 more easily to remove the second protection portion 12.

Optionally, the second division 122 is arranged on at least one side of the first protection portion 11 in the first direction X, and the plurality of second divisions 122 are arranged side by side in the second direction Y. The dimension of the second division 122 on the second direction Y is L3, with 0.1 mm≤L3≤0.4 mm satisfied. Optionally, L3 is 0.1 mm, 0.2 mm, 0.3 mm, or 0.4 mm.

In some embodiments, as shown in FIG. 3, the composite film body 20 includes a cushion layer 23 and a support layer 24 stacked sequentially along a direction towards the first protective layer 10. An orthographic projection of at least one of the support layer 24 or the cushion layer 23 on the first protection layer 10 overlaps with the second protection portion 12.

The support layer 24 can play a supporting and protective role in the composite film body 20, and optionally, the support layer 24 can include a copper foil which can play the role of heat conduction and shielding electric field in addition to the supporting role, so as to meet different needs of the display module and the display device that is formed subsequently.

The cushion layer 23 is positioned on a side of the support layer 24 away from the first protective layer 10, and in the display module and the display device, the cushion layer 23 will be located on a side of the support layer 24 towards the display screen 40, that is, the cushion layer 23 will be arranged to be closer to the display screen 40. When the display device is used, the cushion layer 23 can cushion and reduce a stress to be transmitted to the display screen 40, thereby reducing the influence of external force that the display screen 40 is subjected to, and improve the use reliability of the display device. Optionally, the cushion layer 23 may have a foam structure.

In the embodiments of the present disclosure, the orthographic projection of at least one of the support layer 24 or the cushion layer 23 on the first protection layer 10 overlaps with the second protection portion 12. That is, the second sub-portion 22 includes part of at least one of the support layer 24 or the cushion layer 23, and the second protection portion 12 can support and protect at least one of the support layer 24 or the cushion layer 23, reducing the risk of excessive deformation of the edge of at least one of the support layer 24 or the cushion layer 23 caused by the separation of the second protective layer 30 from the composite film body 20, and improving the preparation reliability and molding yield rate of the display module. Optionally, the orthographic projection of each of the support layer 24 and the cushion layer 23 on the first protection layer 10 overlaps with the second protection portion 12.

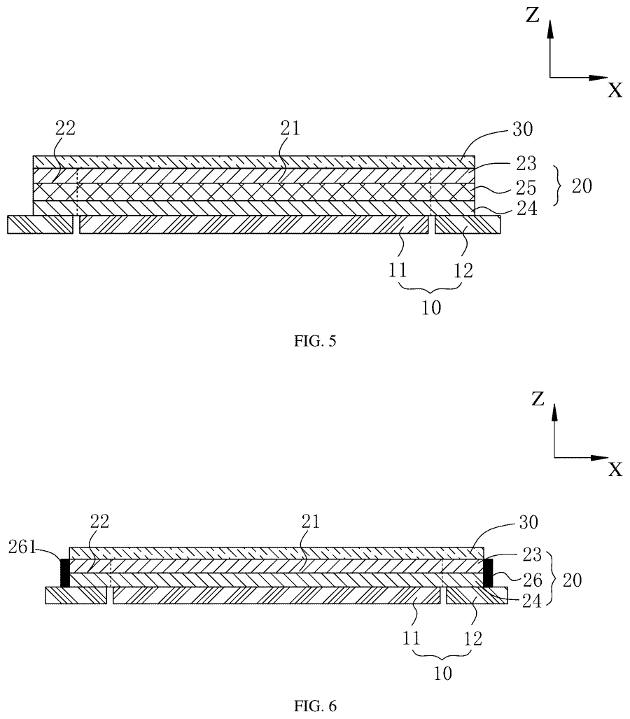

It should be noted that, in addition to the cushion layer 23 and the support layer 24, the composite film body 20 can also include other film layers as required. Optionally, referring to FIG. 5, the composite film body 20 may also include an insulating layer 25 arranged between the support layer 24 and the cushion layer 23.

The insulating layer 25 can insulate and separate the display screen 40 and a middle frame structure 50 in the display device after the display device is subsequently formed. Optionally, the insulating layer 25 may include polyimide (PI). On this basis, the insulating layer 25 can also be used as a substrate for preparing a buffer layer 23 and a support layer 24.

In some optional embodiments, the orthographic projection of the insulating layer 25 on the first protective layer 10 overlaps with the second protective portion 12.

In the embodiments of the present disclosure, the second sub-portion 22 includes part of the insulating layer 25. In order to reduce the risk of excessive deformation at the edge of the insulating layer 25, in the embodiments of the present disclosure, the orthographic projection of the insulating layer 25 on the first protective layer 10 overlaps with the second protective portion 12, so that the second protective portion 12 can support the insulating layer 25 at the edge position, thereby reducing the risk that the second protective portion 12 is excessively pulled and deformed by the second protective layer 30.

In some embodiments, referring to FIG. 6, the composite film body 20 further includes a reinforcing member 26 at least part of which is located in the second sub-portion 22, and a structural strength of the reinforcing member 26 is greater than the structural strength of the support layer 24 and the cushion layer 23.

The reinforcing member 26 includes a rigid material, and the structural strength of the reinforcing member 26 is greater than the structural strength of the support layer 24 and the cushion layer. The structural strength refers to the ability of the structure to resist failure and deformation. Further, the strength of the structure can be tested by means of a compressive test or a tensile test.

The specific material composition of the reinforcing member 26 is not limited in the embodiments of the present disclosure. Optionally, the material of the reinforcing member 26 may include alloy, and compared with other materials, the alloy has a higher hardness parameter, and its size can be set as small as possible to reduce the influence of the reinforcing member 26 on the overall size of the composite film body 20 and reduce the difficulty of the reinforcing member 26 provided inside the composite film body 20. Optionally, the material of the reinforcing member 26 may include stainless steel.

In the embodiments of the present disclosure, with the reinforcing member 26 provided inside the composite film body 20, and at least part of the reinforcing member 26 arranged in the second sub-portion 22, the overall structural strength of the second sub-portion 22 is improved, and the anti-deformation ability of the second sub-portion 22 is increased, so as to further reduce the risk of excessive deformation of the second sub-portion 22 due to the pulling of the second protective layer 30, and improve the reliability.

The specific positional relationship between the reinforcing member 26 and the first protective layer 10 is not limited in the embodiments of the present disclosure. Optionally, the orthographic projection of the reinforcing member 26 on the first protective layer 10 overlaps with the second protection portion 12.

In this case, the reinforcing member 26 and the second protective portion 12 can simultaneously prevent against the deformation of the second sub-portion 22, thereby further reducing the influence of the second protective layer 30 on the second sub-portion 22, reducing the risk of the second sub-portion 22 producing a wavy shape due to excessive deformation, and improving the structural reliability of the second sub-portion 22.

In some embodiments, the reinforcing member 26 is connected with at least one of the support layer 24 or the cushion layer 23.

With the reinforcing member 26 connected to at least one of the support layer 24 or the cushion layer 23, the position reliability of the reinforcing member 26 relative to the support layer 24 and the cushion layer 23 can be improved. At least one of the support layer 24 or the cushion layer 23 can be connected with the reinforcing member 26 in a variety of ways. For example, the reinforcing member 26 can be bonded to at least one of the support layer 24 or the cushion layer 23, or the reinforcing member 26 can also be partially or completely embedded in at least one of the support layer 24 or the cushion layer 23 to meet connection needs.

In some optional embodiments, as shown in FIG. 6, the reinforcing member 26 includes a first reinforcing portion 261 arranged on a periphery side of at least one of the support layer 24 or the cushion layer 23. The first reinforcing portion 261 may be arranged only on the periphery side of the support layer 24, or the first reinforcing portion 261 may also be arranged only on the periphery of the cushion layer 23, or the first reinforcing portion 261 may be arranged on both the periphery side of the support layer 24 and the periphery side of the cushion layer 23.

In the embodiments of the present disclosure, with the first reinforcing portion 261 arranged on the periphery side of at least one of the support layer 24 or the cushion layer 23, an edging structure can be formed on an edge of the periphery side of at least one of the support layer 24 or the cushion layer 23. The first reinforcing portion 261 can pull the edge of the periphery side of at least one of the support layer 24 or the cushion layer 23, so as to reduce the risk of excessive deformation of the edge of the periphery side of at least one of the support layer 24 or the cushion layer 23 due to the separation of the second protective layer 30, thereby improving the structural reliability of at least one of the support layer 24 or the cushion layer 23.

In addition, as the first reinforcing portion 261 is located at the periphery side of at least one of the support layer 24 or the cushion layer 23, the first reinforcing portion 261 can also prevent the water vapor and the like from invading at least one of the support layer 24 or the cushion layer 23 to a certain extent, and improve the use reliability of the display device subsequent formed.

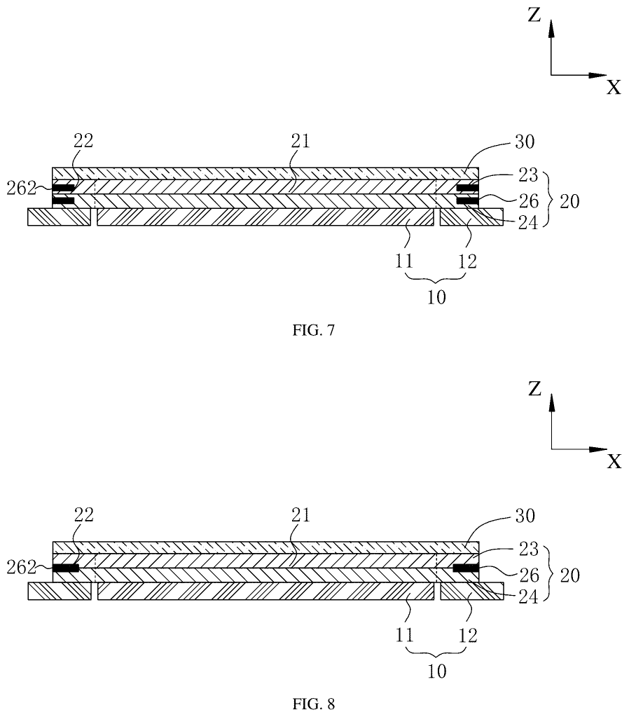

Of course, in some other embodiments, referring to FIG. 7, the reinforcing member 26 includes a second reinforcing portion 262, and the orthographic projection of the second reinforcing portion 262 on the first protective layer 10 overlaps with the orthographic projection of at least one of the support layer 24 or the cushion layer 23 on the first protective layer 10.

In the thickness direction Z, the second reinforcing portion 262 is correspondingly arranged with at least one of the support layer 24 or the cushion layer 23. One or a plurality of second reinforcing portions 262 can be provided. The second reinforcing portion 262 can be provided at a variety of positions. For example, the second reinforcing portion 262 may be at least partially located on a side of the support layer 24 away from the cushion layer 23, or the second reinforcing portion 262 may be located at least partially within the support layer 24, or the second reinforcing portion 262 may be at least partially located within the cushion layer 23, or the second reinforcing portion 262 may be at least partially located on a side of the cushion layer 23 away from the support layer 24.

Optionally, as shown in FIG. 7, at least one of the support layer 24 or the cushion layer 23 is provided with a hollow accommodating space within which the second reinforcing portion 262 is arranged. This design makes the second reinforcing portion 262 can be completely embedded in the support layer 24 or the cushion layer 23, and with the accommodating space, the size of the composite film body 20 will not be additionally increased due to the second reinforcing portion 262, and thus the practicability is strong.

Or in some other optional embodiments, referring to FIG. 8, the second reinforcing portion 262 can be embedded between the support layer 24 and the cushion layer 23, to reduce the preparation difficulty of the second reinforcing portion 262 and improve the preparation efficiency of the composite film body 20.

In the embodiments of the present disclosure, the orthographic projection of the second reinforcing portion 262 on the first protective layer 10 overlaps with the orthographic projection of at least one of the support layer 24 or the cushion layer 23 on the first protective layer 10. In this case, the second reinforcing portion 262 can enhance the structural strength of at least one of the support layer 24 or the cushion layer 23 at the second sub-portion 22, thereby reducing the risk of excessive deformation at the edge of the periphery side of at least one of the support layer 24 or the cushion layer 23, and improving the reliability.

It should be noted that, according to different actual needs, the reinforcing member 26 may only include the first reinforcing portion 261, or may only include the second reinforcing portion 262, or may also include both the first reinforcing portion 261 and the second reinforcing portion 262, which is not limited in the embodiments of the present disclosure.

In some embodiments, the peripheral surface of the second reinforcing portion 262 is flush with the peripheral surface of at least one of the support layer 24 or the cushion layer 23.

The above design helps to improve the flatness of the peripheral surface of the composite film body 20, improves the appearance and perception of the composite film body 20, and simultaneously makes the peripheral surface of the second reinforcing portion 262 be exposed relative to at least one of the support layer 24 or the cushion layer 23, so that the second reinforcing portion 262 can isolate water and oxygen in a certain extent.

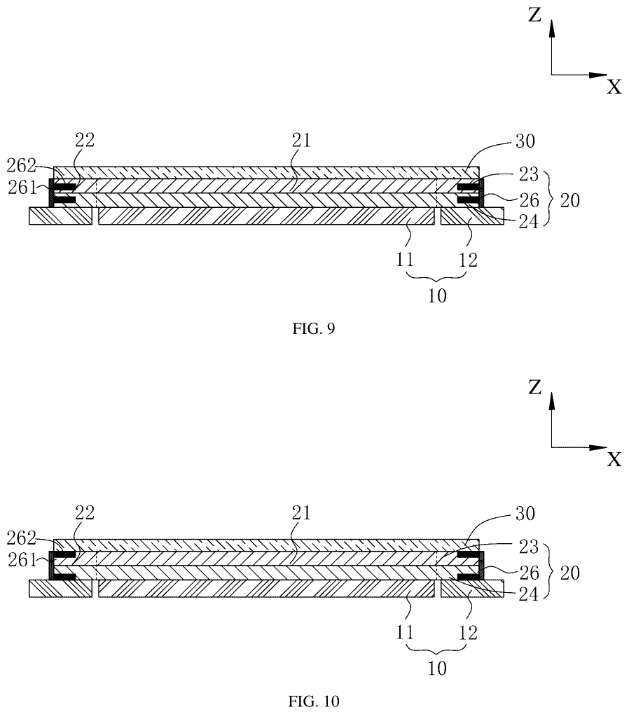

In some embodiments, referring to FIG. 9 and FIG. 10, the reinforcing member 26 includes the first reinforcing portion 261 and the second reinforcing portion 262 connected to the second reinforcing portion 262.

With the reinforcing member 26 including both the first reinforcing portion 261 and the second reinforcing portion 262, the structural strength of the second sub-portion 22 in the composite film body 20 is further improved, the risk of wavy shape due to excessive deformation is reduced, and the overall reliability is improved. Moreover, only one of the first reinforcing portion 261 and the second reinforcing portion 262 needs to be connected and fixed with at least one of the support layer 24 or the cushion layer 23, and the relative position of the other can be fixed, so that the first reinforcing portion 261 or the second reinforcing portion 262 can be selectively connected and fixed with at least one of the support layer 24 or the cushion layer 23 according to different circumstances, and thus the flexibility is strong.

It should be noted that, in the embodiments of the present disclosure, the first reinforcing portion 261 and the second reinforcing portion 262 may be positioned relative to the support layer 24 and the cushion layer 23 in a plurality of relative positions. As shown in FIG. 10, the first reinforcing portion 261 and the second reinforcing portion 262 can jointly form an edging structure covering the edges of the periphery sides of both the support layer 24 and the cushion layer 23. Or as shown in FIG. 9, the first reinforcing portion 261 and the second reinforcing portion 262 may also be embedded in the support layer 24 and the cushion layer 23 by means of the second reinforcing portion 262.

In some embodiments, the first reinforcing portion 261 includes epoxy resin. The epoxy resin can be a glue material, and further, in the preparation process, the glue material can be coated on the edge of the periphery side of the support layer 24 and the cushion layer 23, and then it can be cured to form the first reinforcing portion 261 with higher hardness. Further, in conjunction with the scheme in FIG. 10, optionally, the second reinforcing portion 262 may also include epoxy resin, that is, the first reinforcing portion 261 and the second reinforcing portion 262 are both formed by the glue material that is coated and then cured.

In a second aspect, the embodiments of the present disclosure further provide a composite film structure including the first protective layer 10 and the composite film body 20. The first protective layer 10 includes the first protective portion 11 and the second protective portion 12 arranged on the outer periphery side of the first protective portion 11, and the first protective portion 11 and the second protective portion 12 are separated and connected with each other. The composite film body 20 is arranged on a side of the first protective layer 10 in the thickness direction, and both the first protective portion 11 and the second protective portion 12 abut the composite film body 20.

In the embodiments of the present disclosure, with both the first protection portion 11 and the second protection portion 12 abutting the composite film body 20, the first protection portion 11 and the second protection portion 12 can support and protect the composite film body 20 at different positions. Specifically, the first protection portion 11 can support and protect the composite film body 20 at the central position, and the second protective portion 12 can support and protect the composite film body 20 at the edge position, so as to reduce the deformation influence of the preparation process on the central and edge positions of the composite film body 20 simultaneously, and improve the reliability of the overall structure of the composite film body 20.

Furthermore, with the first protection portion 11 and the second protection portion 12 separated and connected with each other, the reliability of the relative position between the first protection portion 11 and the second protection portion 12 can be improved. At the same time, in this design, it is convenient for separating the second protection portion 12 from the first protection portion 11 subsequently, thus separating the second protection portion 12 from the display screen, to enhance coating process at the edge of the composite film body 20 subsequently and satisfy actual production needs.

In some embodiments, the second protection portion 12 is located on at least one side of the first protection portion 11 in the first direction X, and on the first direction X, the second protection portion 12 is arranged beyond the composite film body 20.

In the embodiments of the present disclosure, the second protective portion 12 is arranged beyond the composite film body 20 in the first direction X, so that the second protective portion 12 can cover the edge of a side of the second sub-portion 22 away from the first sub-portion 21, thus the second protective portion 12 is supported at the edge position of the composite film body 20 to further reduce the risk of wavy shape caused by the deformation of the edge of the composite film body 20.

In some embodiments, the composite film structure further includes a second protective layer 30 located on a side of the composite film body 20 away from the first protective layer 10, and the orthographic projection of the second protective layer 30 on the first protective layer 10 overlaps with the orthographic projection of the second sub-portion 22 on the first protective layer 10.

The second protective layer 30 can have a planar structure and completely cover the composite film body 20, that is, the orthographic projection of the second protective layer 30 on the first protective layer 10 can simultaneously cover the orthographic projection of each of the first sub-portion 21 and the second sub-portion 22 on the first protective layer 10. The contour shape of the second protective layer 30 can be arranged completely corresponding to the contour shape of the composite film body 20, or the second protective layer 30 may also partially exceed the outer contour of the composite film body 20.

In the embodiments of the present disclosure, in the process of separating the second protective layer 30 from the composite film body 20, the pulling deformation of the first sub-portion 21 due to the second protective layer 30 can be reduced by the first protective portion 11, and the pulling deformation of the second sub-portion 22 due to the second protective layer 30 can be reduced by the second protective portion 12, thereby reducing the degree of deformation of the first sub-portion 21 and the second sub-portion 22, reducing the risk of wavy shape appearing at the second sub-portion 22, and improving the structural reliability of the composite film body 20 in the display module, which in turn helps to improve the structural reliability of the final display device.

In some embodiments, as shown in FIG. 1 and FIG. 2, the second protective layer 30 is configured to be separable from the composite film body 20 in the first direction X,

In the embodiments of the present disclosure, the second protection portion 12 is not arranged around the first protection portion 11, but is located on at least one side of the first protection portion 11 along a single direction, that is, the first direction X, so that the second protection portion 12 can be arranged correspondingly with the part of the second sub-portion 22 located on two sides of the first sub-portion 21 in the first direction X, thereby reducing the degree of tension deformation of the part of the second sub-portion 22 located on two sides of the first sub-portion 21 in the first direction X, and improving the structural reliability of the composite film body 20 in the prepared display module.

In some embodiments, the composite film body 20 comprises a first sub-portion 21 and the second sub-portion surrounding the peripheral side of the first sub-portion 21. The composite film body 20 further includes the reinforcing member 26 at least part of which is located in the second sub-portion 22.

A material of the reinforcing member 26 includes a rigid material, and the structural strength of the reinforcing member 26 is large. The structural strength refers to: the ability of the structure to resist damage and deformation. Further, the strength of the structure can be tested by means of a compressive test or a tensile test.

The specific material of the reinforcing member 26 is not limited in the embodiments of the present disclosure. Optionally, the material of the reinforcing member 26 may include alloy, and compared with other materials, the alloy has a higher hardness parameter, and its size can be set as small as possible to reduce the influence of the reinforcing member 26 on the overall size of the composite film body 20 and reduce the difficulty of the reinforcing member 26 provided inside the composite film body 20. Optionally, the material of the reinforcing member 26 may include stainless steel.

In the embodiments of the present disclosure, with the reinforcing member 26 provided inside the composite film body 20, and at least part of the reinforcing member 26 arranged in the second sub-portion 22, the overall structural strength of the second sub-portion 22 is improved, and the anti-deformation ability of the second sub-portion 22 is increased, so as to further reduce the risk of excessive deformation of the second sub-portion 22 due to the pulling of the second protective layer 30, and improve the reliability.

The specific positional relationship between the reinforcing member 26 and the first protective layer 10 is not limited in the embodiments of the present disclosure. Optionally, the orthographic projection of the reinforcing member 26 on the first protective layer 10 overlaps with the second protection portion 12.

In this case, the reinforcing member 26 and the second protective portion 12 can simultaneously prevent against the deformation of the second sub-portion 22, thereby further reducing the influence of the second protective layer 30 on the second sub-portion 22, reducing the risk of the second sub-portion 22 producing a wavy shape due to excessive deformation, and improving the structural reliability of the second sub-portion 22.

In the third aspect, referring to FIG. 11, the embodiments of the present disclosure provide a display module. The display module includes a display screen 40, the composite film body 20 and the first protective layer 10. The display screen 40 includes a light-emitting surface and a backlight surface opposite to each other. The composite film body 20 is arranged on a side of the first protective layer 10 toward the display screen 40, the first protective layer 10 includes the first protection portion 11 and the second protection portion 12 arranged on the outer periphery side of the first protection portion 11, the orthographic projection of the first protective portion 11 on the first protective layer 10 is located in the first protective portion 11, the orthographic projection of the second protective portion 12 on the first protective layer 10 is positioned outside the first protective portion 11, and overlaps with the second protective portion 12.

Before the display module is prepared and formed, the second protective layer 30 is arranged on a side of the composite film body 20 away from the first protective layer 10. In the process of preparing the display module, the second protective layer 30 needs to be separated from the composite film body 20, so that the side the composite film body 20 facing the second protective layer 30 is bonded and fixed to the backlight surface of the display screen 40 to form the display module.

On this basis, with part of the second protective layer 30 and the first protective portion 11 corresponding to the first sub-portion 21 of the composite film body 20, and the other part of the second protective layer 30 and the second protective portion 12 corresponding to the second sub-portion 22 of the composite film body 20, in the process of separating the second protective layer 30 from the composite film body 20, the pulling deformation of the first sub-portion 21 due to the second protective layer 30 can be reduced by the first protective portion 11, and the pulling deformation of the second sub-portion 22 due to the second protective layer 30 can be reduced by the second protective portion 12, thereby reducing the degree of deformation of the first sub-portion 21 and the second sub-portion 22, reducing the risk of wavy shape appearing at the second sub-portion 22, and improving the structural reliability of the composite film body 20 in the prepared display module.

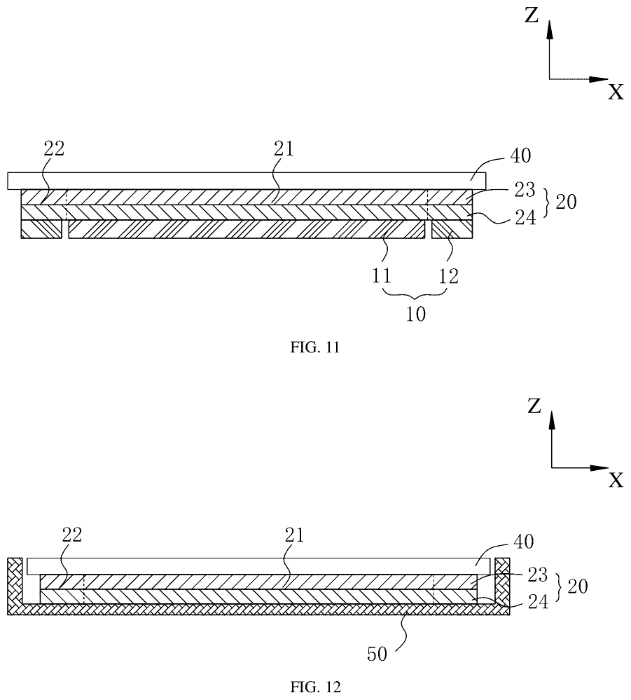

In a fourth aspect, referring to FIG. 12, the embodiments of the present disclosure provide a display device. The display device includes the display screen 40, the composite film body 20 and a middle frame structure 50, the display screen 40 includes the light-emitting surface and the backlight surface, the composite film body 20 is the composite film body 20 in the display module in the aforementioned embodiments, and the composite film body 20 is arranged on a side of the display screen 40 where the backlight surface is located. The middle frame structure 50 is at least partially arranged on a side of the composite film body 20 away from the display screen 40, and abuts the composite film body 20.

The display device can be prepared and molded from the display module. Specifically, the display module includes the display screen 40, the composite film body 20 and the first protective layer 10. In the process of forming the display device, the first protective layer 10 will be separated from the composite film body 20, and then a side of the composite film body 20 towards the first protective layer 10 is bonded and fixed to the middle frame structure 50 to form the display device. The middle frame structure 50 can support and protect the display screen 40.

In this process, the second protective portion 12 in the first protective layer 10 can be separated from the first protective portion 11 and the composite film body 20, and then the first protective portion 11 can be separated from the composite film body 20, so that the side of the composite film body 20 towards the first protective layer 10 can be completely exposed and can be subsequently fixed with the middle frame structure 50.

In some embodiments, the structural strength at the first sub-portion 21 is smaller than the structural strength at the second sub-portion 22.

From the foregoing, it can be seen that in the preparing process of the display module, the composite film body 20 is prone to excessive deformation due to the separation from the second protective layer 30 in the second sub-portion 22, thereby causing the problem of wavy shape. On this basis, in the embodiments of the present disclosure, the structural strength of the second sub-portion 22 is selectively increased to reduce the risk of excessive deformation of the second sub-portion 22 and improve the structural reliability of the composite film body 20 in the display device.

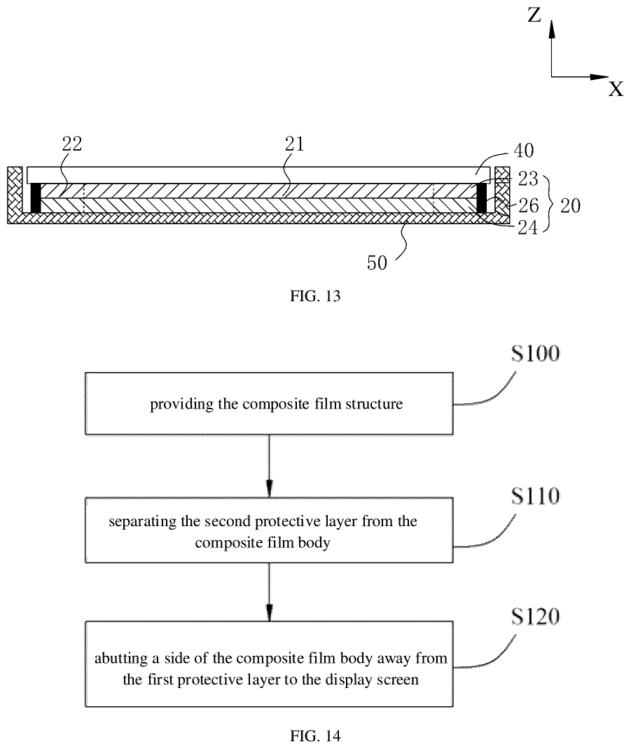

In some optional embodiments, referring to FIG. 13, the composite film body 20 includes the reinforcing member 26 at least of which is located in the second sub-portion 22. In the embodiments of the present disclosure, the reinforcing member 26 is provided in the composite film body 20, and arranged in the second sub-portion 22, thereby helping to improve the overall structural strength of the second sub-portion 22, so that the anti-deformation ability of the second sub-portion 22 is increased, to further reduce the risk of excessive deformation of the second sub-portion 22 in the preparation process of the display device, and improve the reliability.

Optionally, the composite film body 20 includes the cushion layer 23 and the support layer 24 arranged sequentially in the direction far away from the display screen 40, and the reinforcing member 26 includes the first reinforcing portion 261 arranged on the periphery side of at least one of the support layer 24 or the cushion layer 23; and/or, the reinforcing member 26 includes the second reinforcing portion 262. The orthographic projection of the second reinforcing portion 262 on the display screen 40 overlaps with the orthographic projection of at least one of the support layers 24 or the cushion layer 23 on the display screen 40.

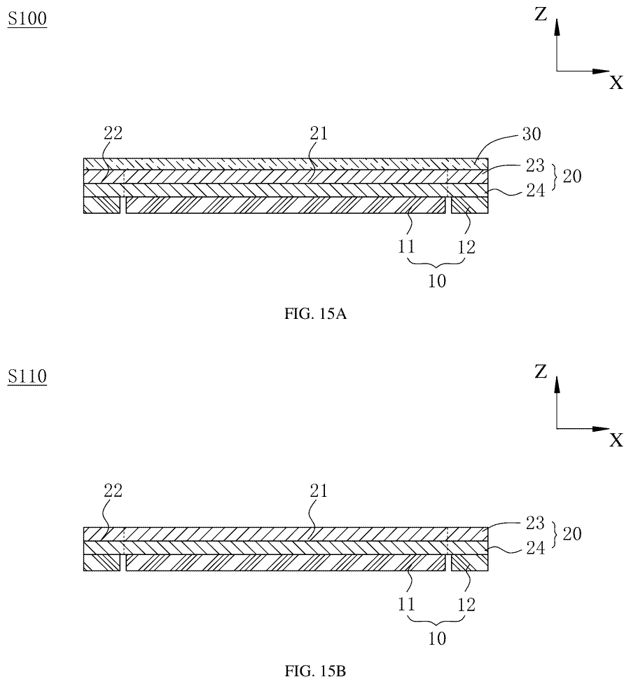

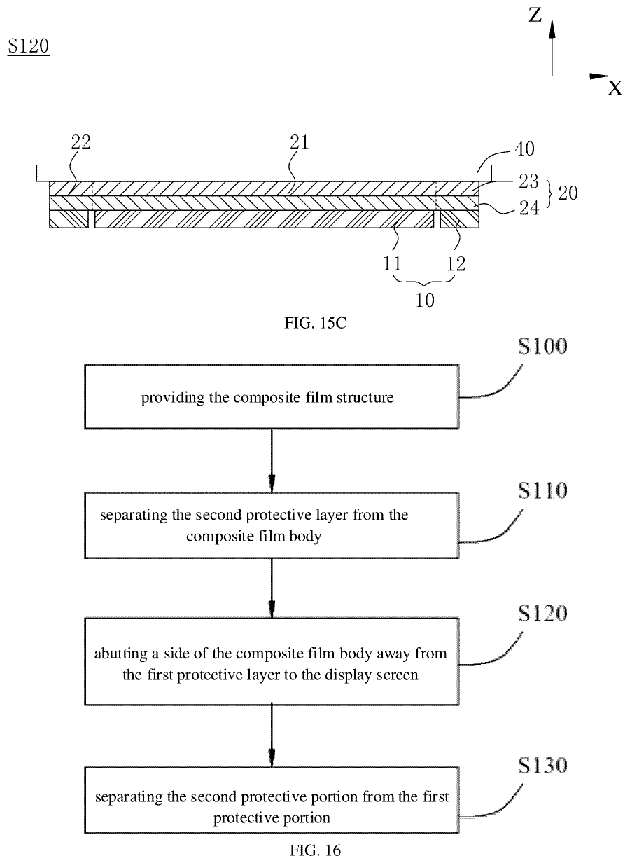

In a fifth aspect, referring to FIG. 14 and FIG. 15, embodiments of the present disclosure provide a preparing method for a display module, including the following steps.

S100: the composite film structure according to any of the preceding embodiments is provided.

Referring to FIG. 15A, in step S100, the composite film structure includes the first protective layer 10, the composite film body 20 and the second protective layer 30, and the first protective layer 10 includes the first protective portion 11 and the second protective portion 12 arranged on the outer periphery side of the first protective portion 11. The composite film body 20 is arranged on the side of the first protective layer 10 in the thickness direction Z. The composite film body 20 includes the first sub-portion 21 and the second sub-portion 22 surrounding the periphery of the first sub-portion 21. The orthographic projection of the first sub-portion 21 on the first protective layer 10 is located in the first protective portion 11, and the orthographic projection of the second sub-portion 22 on the first protective layer 10 is located outside the first protective portion 11, and overlaps with the second protective portion 12.

S110: the second protective layer is separated from the composite film body.

Referring to FIG. 15B, in step S110, in addition to the first protection portion 11, the first protection layer 10 further includes the second protection portion 12. Part of the second protective layer 30 and the first protective portion 11 correspond to the first sub-portion 21 of the composite film body 20, and the other structures of the second protective layer 30 and the second protective portion 12 correspond to the second sub-portion 22 of the composite film body 20. In this way, in the separating process of the second protective layer 30 from the composite film body 20, the pulling deformation of the first sub-portion 21 due to the second protective layer 30 can be reduced by the first protective portion 11, and the pulling deformation of the second sub-portion 22 due to the second protective layer 30 can be reduced by the second protective portion 12, so as to reduce the deformation degree of the first sub-portion 21 and the second sub-portion 22, and reduce the risk of wavy shape at the second sub-portion 22.

S120: the side of the composite film body away from the first protective layer is abutted with the display screen.

Referring to FIG. 15C, in step S120, the part of the composite film body 20 at the second sub-portion 22 is relatively flat, which helps to improve the bonding reliability between the composite film body 20 and the display screen 40, reduces the risk of gap or separation therebetween, and improves the structural reliability of the display module.

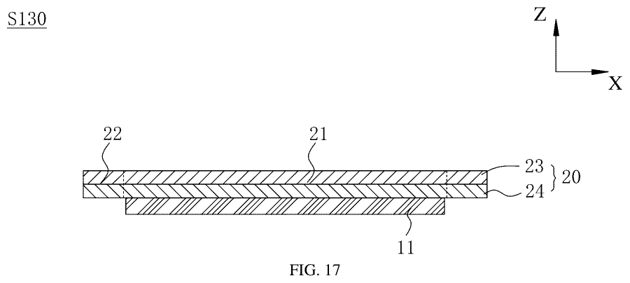

Further, in some embodiments, see FIG. 16 and FIG. 17, and the preparation method further includes:

S130: separating the second protection portion from the first protection portion.

In the embodiments of the present disclosure, after the second protective layer 30 is separated from the composite film body 20, the second protective portion 12 can be separated and removed, so that the second protective portion is separated from the composite film body 20. In this way, the pulling deformation of the second sub-portion 22 due to the second protective layer 30 can be reduced by the second protective portion 12 in the process of separating the second protective layer 30 from the composite film body 20, so as to reduce the deformation degree of the first sub-portion 21 and the second sub-portion 22, and reduce the risk of wavy shape at the second sub-portion 22. In addition, after the second protection portion 12 is separated from the first protection portion 11 and the composite film body 20, it is also convenient to carry out a subsequent edge reinforcement coating process of the composite film body 20 to meet actual production needs.

Although the embodiments as above are disclosed in the present disclosure, the contents described are only embodiments adopted for the convenience of understanding the present disclosure and are not intended to limit the present disclosure. Any one of those skilled in the art to which the present disclosure belongs, on the premise of not departing from the gist and scope disclosed in the present disclosure, may make any modifications and changes in the form and details of the implementation, but the scope of protection of the present disclosure shall still be subject to the scope defined in the attached claims.

The above contents are only specific embodiments of the present disclosure, and those skilled in the art can clearly understand that, for the convenience and conciseness of the description, the replacement of other connection modes described above may refer to the corresponding process in the embodiments of the aforesaid method, and will not be repeated herein. It should be understood that the scope of protection of the present disclosure is not limited thereto, and that those skilled in the art can easily envisage various equivalent modifications or substitutions within the scope of the technology disclosed in the present disclosure, and these modifications or substitutions shall be covered by the scope of protection of the present disclosure.

What is claimed is:

1. A composite film structure for a display module, comprising:
a first protective layer, comprising a first protective portion and at least one second protective portion disposed on an outer periphery side of the first protective portion, and the first protective portion and the second protective portion being at least partially spaced apart from each other; and
a composite film body, disposed on a side of the first protective layer in a thickness direction, and comprising a first sub-portion and a second sub-portion surrounding a periphery of the first sub-portion, an orthographic projection of the first sub-portion on the first protective layer being at least partially located within the first protective portion, and an orthographic projection of the second sub-portion on the first protective layer being located outside the first protective portion and overlapping with the second protective portion.

2. The composite film structure according to claim 1, further comprising a second protective layer disposed on a side of the composite film body away from the first protective layer, wherein an orthographic projection of the second protective layer on the first protective layer overlaps with the orthographic projection of the second sub-portion on the first protective layer.

3. The composite film structure according to claim 2, wherein the second protective layer is configured to be separable from the composite film body along a first direction parallel to a plane where the first protective layer is located; and
the at least one second protective portion is located on at least one side of the first protective portion in the first direction.

4. The composite film structure according to claim 3, wherein a dimension of the composite film body in the first direction is smaller than a dimension of the composite film body in a second direction, the second direction is parallel to the plane where the first protective layer is located and intersecting with the first direction; and
the second protective portion extends in the second direction.

5. The composite film structure according to claim 3, wherein in the first direction, the second protective portion extends beyond the composite film body.

6. The composite film structure according to claim 5, wherein in the first direction, the second protective portion extends beyond the composite film body by L1, and 0.4 mm≤L1≤0.6 mm.

7. The composite film structure according to claim 1, wherein the second protective portion is connected to the first protective portion; and
the second protective portion comprises a first division spaced apart from the first protective portion, and at least one second division connecting the first division to the first protective portion.

8. The composite film structure according to claim 1, wherein the second protective portion is connected to the first protective portion, and the first protective portion and the second protective portion form an integral structure.

9. The composite film structure according to claim 7, wherein the at least one second division comprises a plurality of second divisions arranged at intervals along an outer peripheral edge of the first protective portion.

10. The composite film structure according to claim 1, wherein the composite film body further comprises a cushion layer and a support layer stacked sequentially in a direction towards the first protective layer; and
an orthographic projection of at least one of the support layer or the cushion layer on the first protective layer overlaps with the second protective portion.

11. The composite film structure according to claim 10, wherein the orthographic projection of each of the support layer and the cushion layer on the first protective layer overlaps with the second protective portion;
the composite film body further comprises an insulating layer disposed between the support layer and the cushion layer; and
an orthographic projection of the insulating layer on the first protective layer overlaps with the second protective portion.

12. The composite film structure according to claim 10, wherein the composite film body further comprises a reinforcing member at least partially located within the second sub-portion, with a structural strength of the reinforcing member being greater than that of each of the support layer and the cushion layer.

13. The composite film structure according to claim 12, wherein an orthographic projection of the reinforcing member on the first protective layer overlaps with the second protective portion; and
the reinforcing member is connected to at least one of the support layer or the cushion layer.

14. The composite film structure according to claim 12, wherein the reinforcing member comprises a first reinforcing portion disposed on a periphery side of at least one of the support layer or the cushion layer.

15. The composite film structure according to claim 12, wherein the reinforcing member comprises a second reinforcing portion, and an orthographic projection of the second reinforcing portion on the first protective layer overlaps with the orthographic projection of at least one of the support layer or the cushion layer on the first protective layer.

16. The composite film structure according to claim 15, wherein at least one of the support layer or the cushion layer is provided with a hollow accommodating space, and the second reinforcing portion is disposed within the hollow accommodating space.

17. A composite film structure for a display module, comprising:
a first protective layer, comprising a first protective portion and at least one second protective portion disposed on an outer periphery side of the first protective portion, the first protective portion and the second protective portion being detachably connected to each other; and
a composite film body, disposed on a side of the first protective layer in a thickness direction, with both the first protective portion and the second protective portion attached to the composite film body.

18. The composite film structure according to claim 17, wherein the at least one second protective portion is located on at least one side of the first protective portion in a first direction parallel to a plane where the first protective layer is located, and the second protective portion extends beyond the composite film body in the first direction.

19. The composite film structure according to claim 17, wherein the composite film body further comprises a first sub-portion and a second sub-portion surrounding a periphery of the first sub-portion;
the composite film body further comprises a reinforcing member at least partially located within the second sub-portion; and
an orthographic projection of the reinforcing member on the first protective layer overlaps with the second protective portion.

20. A display module, comprising:
a display screen with a light-emitting surface and a backlight surface opposite to each other; and
the composite film structure according to claim 1, wherein the composite film body is disposed on a side of the display screen where the backlight surface is provided, and the first protective layer is disposed on a side of the composite film body away from the display screen.
